(19) United States
(12) Patent Application Publication
(10) Pub. No.: US 2025/0376072 A1
(43) Pub. Date: Dec. 11, 2025

(54) VEHICLE

(71) Applicant: SUBARU CORPORATION, Tokyo (JP)

(72) Inventors: Takahiro UCHIMURA, Tokyo (JP); Yuichi SUZUKI, Tokyo (JP)

(21) Appl. No.: 19/203,254

(22) Filed: May 9, 2025

(30) Foreign Application Priority Data
Jun. 6, 2024 (JP) 2024-092514

(51) Int. Cl. B60L 58/12; B60L 1/00; G07C 5/00; G07C 5/08; G07C 5/10

(52) U.S. Cl. CPC B60L 58/12; B60L 1/00; G07C 5/008; G07C 5/0825; G07C 5/10

(57) ABSTRACT

A vehicle includes a first storage, a first position data obtainer, a first determiner, and a first display processor. The first storage is configured to hold: data on a location where electric power of a drive battery has been used for external power supply; and data including a power consumption used in the external power supply. The first position data obtainer is configured to acquire current position data on the vehicle. The first determiner is configured to determine whether the current position data is same as or similar to the data on the location. The first display processor is configured to, when the first determiner determines that the current position data is the same as or similar to the data on the location, cause a display to display the data including the power consumption used in the external power supply in the past.

### CROSS-REFERENCE TO RELATED APPLICATIONS

The present application claims priority from Japanese Patent Application No. 2024-092514 filed on Jun. 6, 2024, the entire contents of which are hereby incorporated by reference.

### BACKGROUND

The disclosure relates to a vehicle.

In recent years, an electric vehicle including a drive battery chargeable by an external power source has been spread in terms of environmental protection.

A recent electric vehicle including a drive battery in which electric power for traveling is held converts the electric power held in the drive battery into alternating-current electric power and supplies the alternating-current electric power to an external device through an electrical outlet installed inside or outside the electric vehicle.

Even in a location, such as a campground or a disaster area, where electric power supply is difficult to obtain, a user can acquire the electric power from the electric vehicle to thereby use a refrigerator or a television, charge a smartphone, or perform any other activity.

As a technique of this kind, Japanese Unexamined Patent Application Publication (JP-A) No. 2012-29483 discloses a technique of terminating external power supply using electric power of a drive battery when a state of charge of the drive battery falls below a lower limit.

### SUMMARY

An aspect of the disclosure provides a vehicle including a first storage, a first position data obtainer, a first determiner, and a first display processor. The first storage is configured to hold: data on a location where electric power of a drive battery has been used for external power supply; and data including a power consumption used in the external power supply. The data on the location is linked with the data including the power consumption. The first position data obtainer is configured to, when the vehicle stops traveling, acquire current position data on the vehicle. The first determiner is configured to determine whether the current position data is same as or similar to the data on the location where the external power supply has been performed in past. The first display processor is configured to, when the first determiner determines that the current position data is the same as or similar to the data on the location where the external power supply has been performed in the past, cause a display to display the data including the power consumption used in the external power supply in the past.

An aspect of the disclosure provides a vehicle including a second storage, a second position data obtainer, a state-of-charge processor, a second determiner, and a second display processor. The second storage is configured to hold: data on a location where electric power of a drive battery has been used for external power supply; and data including a power consumption used in the external power supply. The data on the location is linked with the data including the power consumption. The second position data obtainer is configured to acquire current position data on the vehicle. The state-of-charge processor is configured to calculate a state of charge of the drive battery to be obtained upon arrival at a destination, based on the current position data. The second determiner is configured to determine whether location data on the destination is same as or similar to the data on the location where the external power supply has been performed in past. The second display processor is configured to, when the second determiner determines that the location data on the destination is the same as or similar to the data on the location where the external power supply has been performed in the past, cause a display to display data including the state of charge of the drive battery to be obtained upon the arrival at the destination and the power consumption used in the external power supply in the past.

An aspect of the disclosure provides a vehicle including a control processor and a display. The control processor includes one or more processors, and one or more memories communicably coupled to the one or more processors. The one or more memories include a storage configured to hold: data on a location where electric power of a drive battery has been used for external power supply; and data including a power consumption used in the external power supply. The data on the location is linked with the data including the power consumption. The one or more processors are configured to, when determining that current position data on the vehicle acquired upon stopping traveling of the vehicle is same as or similar to the data on the location where the external power supply has been performed in past, cause the display to display the data including the power consumption used in the external power supply in the past.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating an exemplary configuration of a vehicle according to one example embodiment of the disclosure.

FIG. 2 is another block diagram illustrating the exemplary configuration of the vehicle illustrated in FIG. 1.

FIG. 3 is a table illustrating exemplary external-power-supply use history data to be generated by the vehicle illustrated in FIGS. 1 and 2.

FIG. 4 is a diagram illustrating an exemplary display mode of data to be displayed by the vehicle illustrated in FIGS. 1 and 2.

FIG. 5 is a diagram illustrating an exemplary display mode of data that the vehicle illustrated in FIGS. 1 and 2 causes a user terminal to display.

FIG. 6 is a flowchart illustrating exemplary processing to be performed by the vehicle illustrated in FIGS. 1 and 2.

FIG. 7 is a flowchart illustrating other exemplary processing to be performed by the vehicle illustrated in FIGS. 1 and 2.

FIG. 8 is a block diagram illustrating an exemplary configuration of a vehicle according to one example embodiment of the disclosure.

FIG. 9 is another block diagram illustrating the exemplary configuration of the vehicle illustrated in FIG. 8.

FIG. 10 is a table illustrating exemplary external-power-supply use history data to be generated by the vehicle illustrated in FIGS. 8 and 9.

FIG. 11 is a diagram illustrating an exemplary display mode of data to be displayed by the vehicle illustrated in FIGS. 8 and 9.

FIG. 12 is a flowchart illustrating exemplary processing to be performed by the vehicle illustrated in FIGS. 8 and 9.

FIG. 13 is a block diagram illustrating an exemplary configuration of a vehicle according to one example embodiment of the disclosure.

FIG. 14 is another block diagram illustrating the exemplary configuration of the vehicle illustrated in FIG. 13.

FIG. 15 is a diagram illustrating an exemplary display mode of data to be displayed by the vehicle illustrated in FIGS. 13 and 14.

FIG. 16 is a flowchart illustrating exemplary processing to be performed by the vehicle illustrated in FIGS. 13 and 14.

### DETAILED DESCRIPTION

In a technique disclosed in JP-A No. 2012-29483, at a time point when arriving at a location such as a campground, a user has a difficulty in estimating how much electric power he/she is to consume at the campground.

It is desirable to provide a vehicle that makes it possible for a user to estimate a power consumption.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

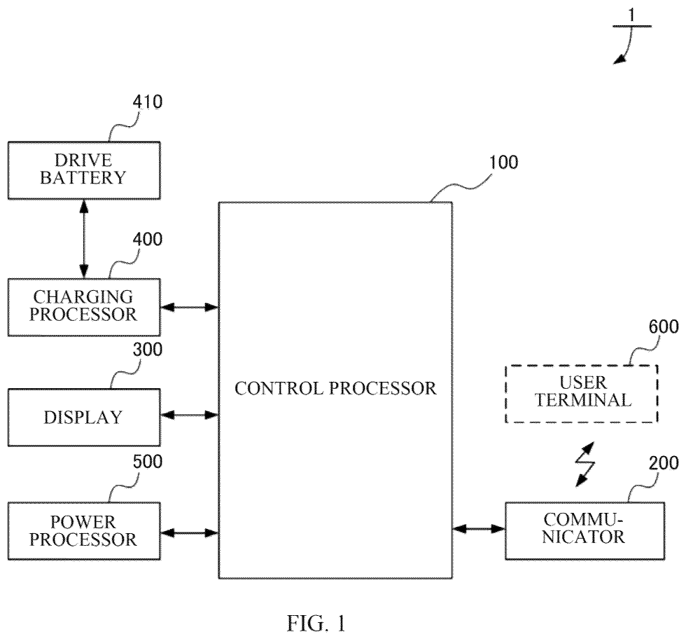

In the following, some example embodiments of the disclosure will be described with reference to FIGS. 1 to 16.

### First Example Embodiment

A vehicle 1 according to a first example embodiment of the disclosure will now be described with reference to FIGS. 1 to 7.

### <Configuration of Vehicle 1>

Referring to FIG. 1, the vehicle 1 according to the present example embodiment may include a control processor 100, a communicator 200, a display 300, a charging processor 400, a drive battery 410, and a power processor 500.

Note that details of a configuration of the control processor 100 will be described later.

In the present example embodiment, the communicator 200 may be a device, such as a known wireless communication module, that transmits data outputted from the control processor 100 to a user terminal 600.

Non-limiting examples of the user terminal 600 may include a smartphone and a tablet.

The communicator 200 may transmit the data to the user terminal 600 by a method such as communication via the Internet or short-range wireless communication via Bluetooth or a wireless local area network (LAN).

In the present example embodiment, the communicator 200 may transmit data such as data on a history of use of external power supply (hereinafter referred to as “external-power-supply use history data”) outputted from the control processor 100 to the user terminal 600.

The user terminal 600 may cause its unillustrated display to display the external-power-supply use history data received from the communicator 200.

Note that a display mode of the external-power-supply use history data to be displayed on the user terminal 600 will be described later.

In the present example embodiment, the display 300 may be a display panel, such as a liquid crystal panel, that is installed in a vehicle compartment of the vehicle 1 and displays data under the control of the control processor 100.

In the present example embodiment, the display 300 may display data such as the external-power-supply use history data under the control of the control processor 100.

Note that a display mode of the external-power-supply use history data to be displayed by the display 300 will be described later.

In the present example embodiment, the charging processor 400 may control processing such as charging the drive battery 410 for travel of the vehicle 1 or performing the external power supply using electric power of the drive battery 410.

The charging processor 400 may control a device such as an unillustrated inverter to convert the electric power of the drive battery 410 into alternating-current electric power and supply the alternating-current electric power through a port such as an electrical outlet installed inside or outside the vehicle 1.

In the present example embodiment, the charging processor 400 may detect data such as a state of charge (SOC) of the drive battery 410.

In the present example embodiment, upon receiving a request for acquisition of SOC data from the control processor 100 to be described later, the charging processor 400 may output the SOC data on the drive battery 410 to the control processor 100.

In the present example embodiment, the power processor 500 may control a condition such as a timing of supplying electric power to respective devices included in the vehicle 1.

In the present example embodiment, the power processor 500 may detect data including an on state and an off state of a power switch operated by a user in starting up and stopping the vehicle 1, and output a detection result to the control processor 100.

### <Configuration of Control Processor 100>

The control processor 100 includes one or more processors, and one or more memories communicably coupled to the one or more processors.

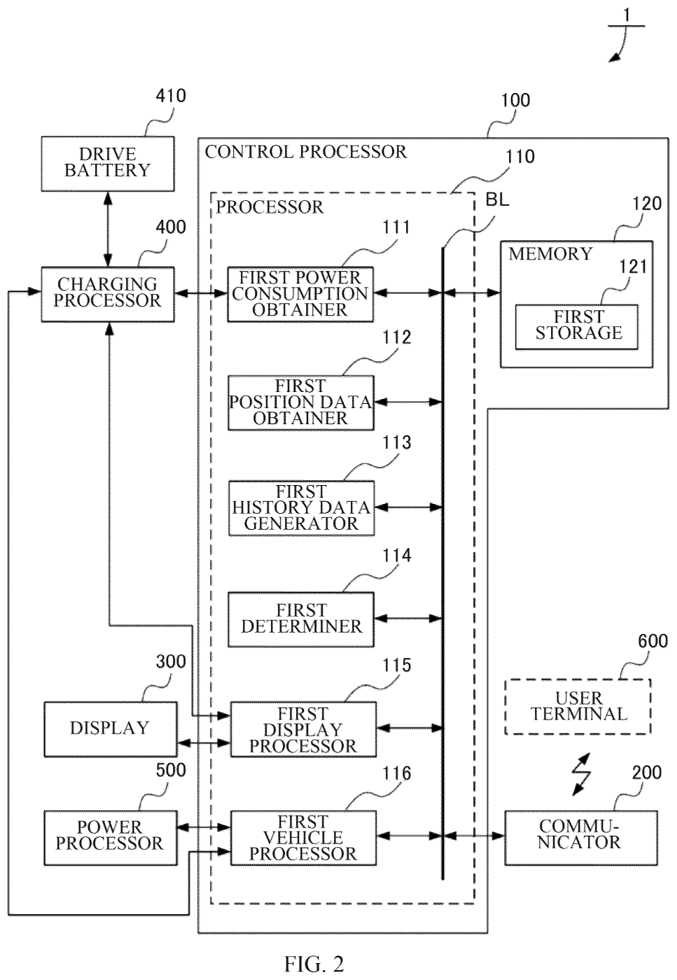

Referring to FIG. 2, the control processor 100 according to the present example embodiment may include a processor 110 and a memory 120.

The processor 110 and the memory 120 may input and output data to each other via a bus line BL.

Note that a configuration of the processor 110 will be described later.

The memory 120 may include an unillustrated storage such as a read-only memory (ROM) or a random-access memory (RAM).

The memory 120 may hold a control program, various types of data outputted from the processor 110, and any other data.

In the present example embodiment, the memory 120 may include a first storage 121.

The first storage 121 may hold the external-power-supply use history data in which data on a location where the electric power of the drive battery 410 has been used for the external power supply is linked with data including a power consumption used in the external power supply (hereinafter referred to as an “external-power-supply power consumption”).

In the present example embodiment, the first storage 121 may hold the external-power-supply use history data outputted from the processor 110 to be described later.

Note that the external-power-supply use history data to be held in the first storage 121 will be described later.

### <Configuration of Processor 110>

As illustrated in FIG. 2, the processor 110 may include a first power consumption obtainer 111, a first position data obtainer 112, a first history data generator 113, a first determiner 114, a first display processor 115, and a first vehicle processor 116.

The first power consumption obtainer 111 may acquire the external-power-supply power consumption used by the user.

In the present example embodiment, the first power consumption obtainer 111 may acquire data on the external-power-supply power consumption used by the user (hereinafter referred to as “external-power-supply power consumption data”), based on data such as the SOC of the drive battery 410.

In the present example embodiment, upon receiving input such as data indicating that the vehicle 1 has stopped from the first vehicle processor 116 to be described later, the first power consumption obtainer 111 may output a request for the acquisition of the SOC data to the charging processor 400, and acquire the SOC data on the drive battery 410.

In the present example embodiment, upon receiving input such as data indicating that the vehicle 1 has started up from the first vehicle processor 116 to be described later, the first power consumption obtainer 111 may output a request for the acquisition of the SOC data to the charging processor 400, and acquire the SOC data on the drive battery 410.

In the present example embodiment, the first power consumption obtainer 111 may calculate a difference value of a difference between a value of the SOC data on the drive battery 410 acquired upon stopping the vehicle 1 and a value of the SOC data on the drive battery 410 acquired upon starting up the vehicle 1.

In the present example embodiment, the first power consumption obtainer 111 may output, to the first history data generator 113 to be described later via the bus line BL, data including the SOC data on the drive battery 410 acquired upon stopping the traveling of the vehicle 1, the SOC data on the drive battery 410 acquired upon starting up the vehicle 1, and the difference value (i.e., the external-power-supply power consumption).

When the vehicle 1 stops traveling, the first position data obtainer 112 acquires current position data on the vehicle 1.

In the present example embodiment, upon receiving the data indicating that the vehicle 1 has stopped traveling from the first vehicle processor 116 to be described later, the first position data obtainer 112 may acquire the position data on the vehicle 1 (e.g., its latitude and longitude) together with time data, based on electric waves received from satellites of a positioning system such as the Global Positioning System (GPS).

In the present example embodiment, the first position data obtainer 112 may output the acquired position data and time data to the first history data generator 113 and the first determiner 114 to be described later via the bus line BL.

The first history data generator 113 may generate the external-power-supply use history data in which the data on the location where the external power supply has been performed is linked with the data including the external-power-supply power consumption data.

In the present example embodiment, the first history data generator 113 may generate the external-power-supply use history data in which the position data and the time data received from the first position data obtainer 112 are linked with the external-power-supply power consumption data received from the first power consumption obtainer 111.

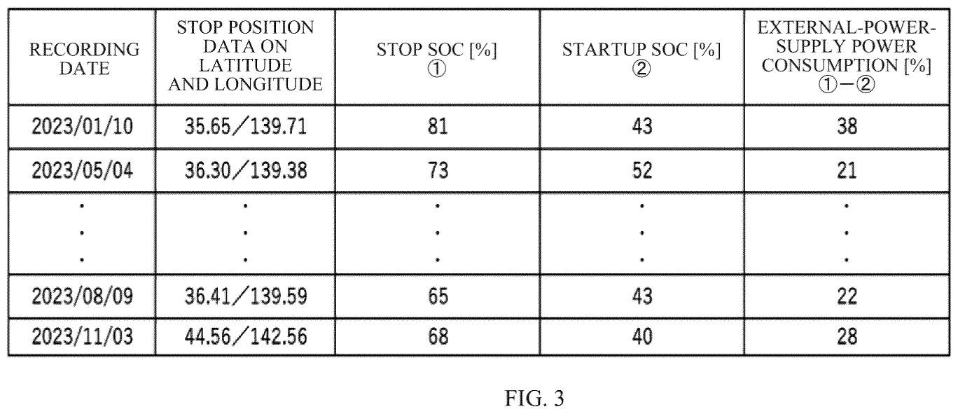

An example of the external-power-supply use history data will now be described with reference to FIG. 3.

In the example illustrated in FIG. 3, the first history data generator 113 according to the present example embodiment may generate the external-power-supply use history data in which a recording date, stop position data, a stop SOC, a startup SOC, and the external-power-supply power consumption are linked with each other.

In some embodiments, a value of the time data received from the first position data obtainer 112 may be registered as the recording date.

In some embodiments, a value of the position data received from the first position data obtainer 112 may be registered as the stop position data.

In some embodiments, a value of the SOC data on the drive battery 410 acquired upon stopping the traveling of the vehicle 1, received from the first power consumption obtainer 111 may be registered as the stop SOC.

In some embodiments, a value of the SOC data on the drive battery 410 acquired upon starting up the vehicle 1, received from the first power consumption obtainer 111 may be registered as the startup SOC.

In some embodiments, the difference value (i.e., a value of the external-power-supply power consumption) received from the first power consumption obtainer 111 may be registered as the external-power-supply power consumption.

In this example, the respective registered values of the stop SOC, the startup SOC, and the external-power-supply power consumption may be each determined provided that a fully charged state of the drive battery 410 is defined as 100%.

In the present example embodiment, the first history data generator 113 may output the generated external-power-supply use history data to the first storage 121 via the bus line BL, and cause the first storage 121 to hold the external-power-supply use history data.

In some embodiments where the value of the external-power-supply power consumption received from the first power consumption obtainer 111 is less than or equal to 1%, the first history data generator 113 may refrain from generating the external-power-supply use history data.

The first determiner 114 determines whether the current position data on the vehicle 1 acquired from the first position data obtainer 112 is the same as or similar to the location data on the location where the external power supply has been performed in the past.

In the present example embodiment, upon receiving input such as the position data from the first position data obtainer 112, the first determiner 114 may determine whether the vehicle 1 has a history of stopping within a predetermined distance, such as 500 meters, from the current position, based on the stop position data included in the external-power-supply use history data held in the first storage 121.

If determining that the vehicle 1 has the history of stopping within the predetermined distance, such as 500 meters, from the current position, the first determiner 114 may output a determination result indicating that the vehicle 1 has the history of stopping within the predetermined distance, such as 500 meters, from the current position as well as the external-power-supply use history data obtained on a past date when the vehicle 1 has stopped traveling within the predetermined distance, such as 500 meters, from the current position, to the first display processor 115 and the first vehicle processor 116 to be described later via the bus line BL.

If determining that the vehicle 1 has no history of stopping within the predetermined distance, such as 500 meters, from the current position, the first determiner 114 may output a determination result indicating that the vehicle 1 has no history of stopping within the predetermined distance, such as 500 meters, from the current position, to the first display processor 115 and the first vehicle processor 116 to be described later via the bus line BL.

In some embodiments where the vehicle 1 has a plurality of histories of stopping within the predetermined distance, such as 500 meters, from the current position, the first determiner 114 may output all of corresponding pieces of the external-power-supply use history data to the first display processor 115 and the first vehicle processor 116 to be described later.

If the first determiner 114 determines that the current position data acquired from the first position data obtainer 112 is the same as or similar to the location data on the location where the external power supply has been performed in the past, the first display processor 115 causes the display 300 to display data including past external-power-supply power consumption.

In the present example embodiment, upon receiving the determination result indicating that the vehicle 1 has the history of stopping within the predetermined distance, such as 500 meters, from the current position from the first determiner 114, the first display processor 115 may cause the display 300 to display the external-power-supply use history data received from the first determiner 114.

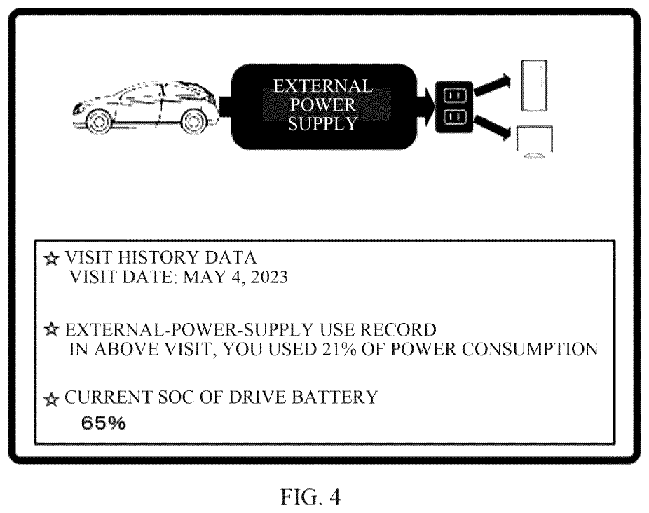

In the example illustrated in FIG. 4, the first display processor 115 may cause the display 300 to display visit history data and an external-power-supply use record, based on the external-power-supply use history data received from the first determiner 114.

In the present example embodiment, upon receiving the data indicating that the vehicle 1 has stopped from the first vehicle processor 116 to be described later, the first display processor 115 may output a request for the acquisition of the SOC data to the charging processor 400, and acquire the SOC data on the drive battery 410.

In the example illustrated in FIG. 4, the first display processor 115 may cause the display 300 to display the SOC data on the drive battery 410 acquired from the charging processor 400.

In some embodiments, upon receiving a plurality of external-power-supply use histories from the first determiner 114, the first display processor 115 may cause the display 300 to display data on all of the received external-power-supply use histories.

In the present example embodiment, upon receiving the determination result indicating that the vehicle 1 has no history of stopping within the predetermined distance, such as 500 meters, from the current position from the first determiner 114, the first display processor 115 may cause the display 300 to display data indicating that the vehicle 1 has no external-power-supply use history.

In the present example embodiment, the first vehicle processor 116 may control processing of an entirety of the vehicle 1 in accordance with the control program held in the memory 120.

In the present example embodiment, the first vehicle processor 116 may acquire data including the on state and the off state of the power switch from the power processor 500, and determine whether the power switch has changed from the on state to the off state.

In the present example embodiment, if determining that the power switch has changed from the on state to the off state, the first vehicle processor 116 may output the data indicating that the vehicle 1 has stopped, to the first power consumption obtainer 111, the first position data obtainer 112, and the first display processor 115 via the bus line BL.

In the present example embodiment, if determining that the power switch has changed from the on state to the off state, the first vehicle processor 116 may output a request for the acquisition of the SOC data to the charging processor 400, and acquire the SOC data on the drive battery 410.

In the present example embodiment, the first vehicle processor 116 may acquire data including the on state and the off state of the power switch from the power processor 500, and determine whether the power switch has changed from the off state to the on state.

In the present example embodiment, if determining that the power switch has changed from the off state to the on state, the first vehicle processor 116 may output the data indicating that the vehicle 1 has started up, to the first power consumption obtainer 111 via the bus line BL.

In the present example embodiment, if the first determiner 114 determines that the current position data is the same as or similar to the location data on the location where the external power supply has been performed in the past, the first vehicle processor 116 may control processing of transmitting data including the past external-power-supply power consumption to the user terminal 600.

In the present example embodiment, the first vehicle processor 116 may generate display screen data to be displayed on the user terminal 600, based on data including the external-power-supply use history data received from the first determiner 114.

In the present example embodiment, the first vehicle processor 116 may control a device such as the communicator 200 to transmit the generated display screen data to the user terminal 600.

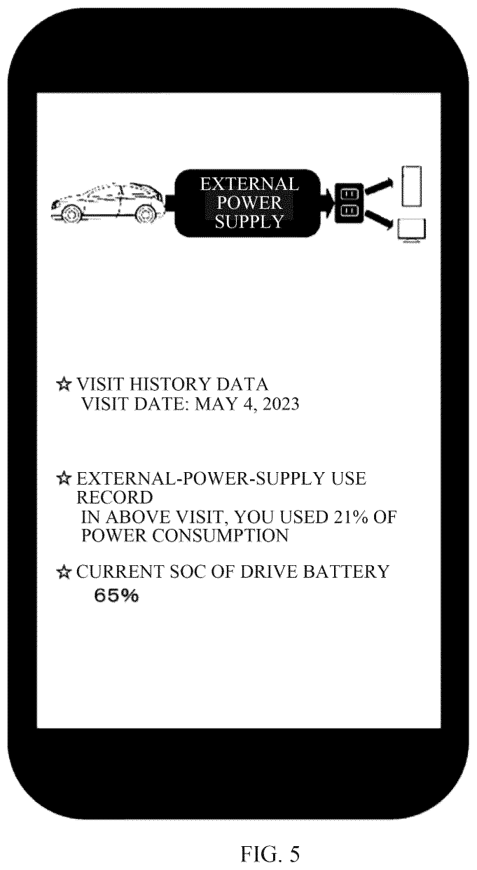

The first vehicle processor 116 may cause the user terminal 600 to display the display screen data in an exemplary display mode illustrated in FIG. 5.

In the example illustrated in FIG. 5, the first vehicle processor 116 according to the present example embodiment may cause the user terminal 600 to display data including the visit history data and the external-power-supply use record, based on the external-power-supply use history data received from the first determiner 114.

In this example, the first vehicle processor 116 according to the present example embodiment may cause the user terminal 600 to display the current SOC data on the drive battery 410 acquired from the charging processor 400.

In the present example embodiment, upon receiving data indicating that the vehicle 1 has no history of stopping within the predetermined distance, such as 500 meters, from the current position from the first determiner 114, the first vehicle processor 116 may cause the user terminal 600 to display the data indicating that the vehicle 1 has no external-power-supply use history.

### <Flow of Processing of Generating External-Power-Supply Use History Data to be Performed by Vehicle 1>

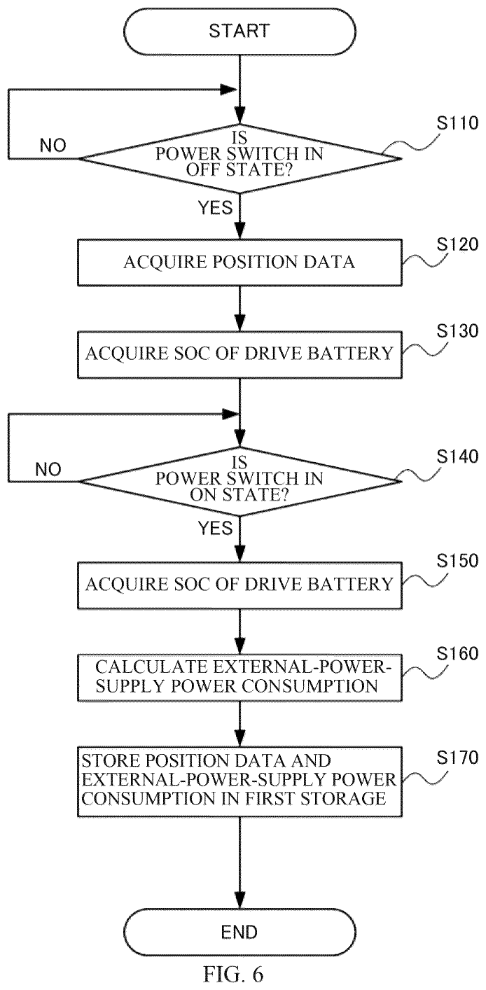

An exemplary flow of processing of generating the external-power-supply use history data to be held in the first storage 121 of the vehicle 1 will now be described with reference to FIG. 6.

The first vehicle processor 116 may determine whether the power switch has changed from the on state to the off state, based on data acquired from the power processor 500 (step S110).

If determining that the power switch has not changed from the on state to the off state, based on the data acquired from the power processor 500 (step S110: NO), the first vehicle processor 116 may return the processing and shift to a standby state.

If determining that the power switch has changed from the on state to the off state, based on the data acquired from the power processor 500 (step S110: YES), the first vehicle processor 116 may cause the processing to proceed to step S120.

The first vehicle processor 116 may cause the first position data obtainer 112 to acquire the position data on the vehicle 1 (step S120), and cause the processing to proceed to step S130.

The first power consumption obtainer 111 may acquire the SOC of the drive battery 410 from the charging processor 400 (step S130), and cause the processing to proceed to step S140.

The first vehicle processor 116 may determine whether the power switch has changed from the off state to the on state, based on data acquired from the power processor 500 (step S140).

If determining that the power switch has not changed from the off state to the on state, based on the data acquired from the power processor 500 (step S140: NO), the first vehicle processor 116 may return the processing and shift to the standby state.

If determining that the power switch has changed from the off state to the on state, based on the data acquired from the power processor 500 (step S140: YES), the first vehicle processor 116 may cause the processing to proceed to step S150.

The first power consumption obtainer 111 may acquire the SOC of the drive battery 410 from the charging processor 400 (step S150), and cause the processing to proceed to step S160.

The first power consumption obtainer 111 may calculate the external-power-supply power consumption, based on the SOC of the drive battery 410 acquired in step S130 and the SOC of the drive battery 410 acquired in step S150 (step S160), and cause the processing to proceed to step S170.

The first history data generator 113 may cause the first storage 121 to hold the external-power-supply use history data in which the position data acquired in step S120 is linked with the respective pieces of the data acquired in steps S130, S150, and S160 (step S170), and end the processing.

### <Flow of Processing of Displaying External-Power-Supply Use History Data to be Performed by Vehicle 1>

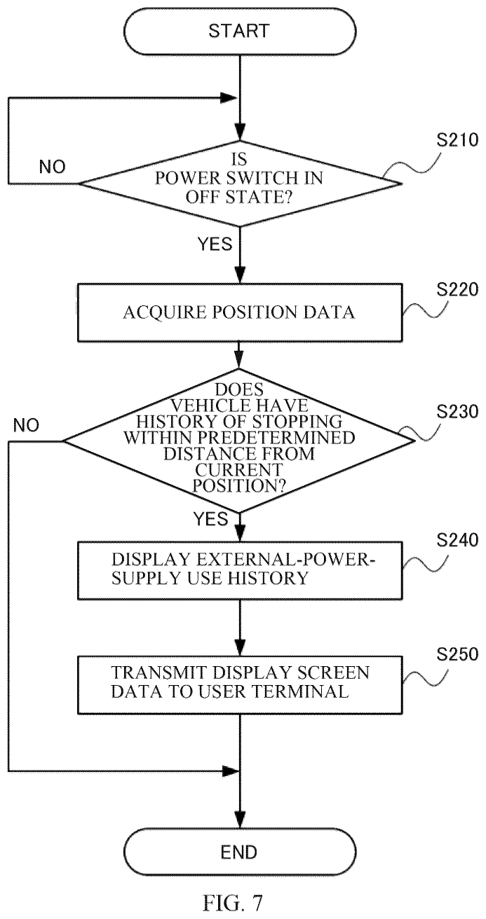

An exemplary flow of processing of causing the display 300 to display the external-power-supply use history data to be performed by the vehicle 1 will now be described with reference to FIG. 7.

The first vehicle processor 116 may determine whether the power switch has changed from the on state to the off state, based on data acquired from the power processor 500 (step S210).

If determining that the power switch has not changed from the on state to the off state, based on the data acquired from the power processor 500 (step S210: NO), the first vehicle processor 116 may return the processing and shift to the standby state.

If determining that the power switch has changed from the on state to the off state, based on the data acquired from the power processor 500 (step S210: YES), the first vehicle processor 116 may cause the processing to proceed to step S220.

The first vehicle processor 116 may cause the first position data obtainer 112 to acquire the position data on the vehicle 1 (step S220), and cause the processing to proceed to step S230.

The first determiner 114 may determine whether the vehicle 1 has the history of stopping within the predetermined distance, such as 500 meters, from the current position, based on the position data on the vehicle 1 acquired in step S220 and the stop position data included in the external-power-supply use history data held in the first storage 121 (step S230).

If determining that the vehicle 1 has no history of stopping within the predetermined distance, such as 500 meters, from the current position (step S230: NO), the first determiner 114 may end the processing.

If determining that the vehicle 1 has the history of stopping within the predetermined distance, such as 500 meters, from the current position (step S230: YES), the first determiner 114 may cause the processing to proceed to step S240.

The first display processor 115 may cause the display 300 to display the external-power-supply use history data and the SOC data on the drive battery 410 (step S240), and cause the processing to proceed to step S250.

The first vehicle processor 116 may control the communicator 200 to transmit the display screen data (data including the external-power-supply use history data and the SOC data on the drive battery 410) to the user terminal 600 (step S250), and end the processing.

### Workings and Example Effects

In the example embodiments described above, the vehicle 1 includes the first storage 121, the first position data obtainer 112, the first determiner 114, and the first display processor 115. The first storage 121 is configured to hold: the data on the location where the electric power of the drive battery 410 has been used for the external power supply; and the data including the external-power-supply power consumption. The data on the location is linked with the data including the external-power-supply power consumption. The first position data obtainer 112 is configured to, when the vehicle 1 stops traveling, acquire the current position data on the vehicle 1. The first determiner 114 is configured to determine whether the acquired current position data is the same as or similar to the location data on the location where the external power supply has been performed in the past. The first display processor 115 is configured to, when the first determiner 114 determines that the acquired current position data is the same as or similar to the location data on the location where the external power supply has been performed in the past, cause the display 300 to display the data including the past external-power-supply power consumption.

In other words, the vehicle 1 may cause the display 300 to display the external-power-supply power consumption data on the past external-power-supply power consumption, when the vehicle 1 is determined to have performed the external power supply at a position where the vehicle 1 has stopped traveling, in the past.

Such a configuration helps to allow the user to acquire past external-power-supply use history data and estimate a power consumption to be used upon current stopping of the vehicle 1.

This configuration helps to allow the user to estimate the power consumption to be used upon current stopping of the vehicle 1, based on types and the number of devices operated by the external power supply in a past visit, the displayed external power supply use history, and types and the number of devices to be operated by the external power supply in a current visit.

In such a situation where the number of devices to be operated by the external power supply is less in the current visit than in the past visit, the configuration helps to allow the user to estimate that the external-power-supply power consumption is to become less in the current visit than in the past visit.

In some embodiments, the vehicle 1 may cause the display 300 to display the external-power-supply use history data and the current SOC of the drive battery 410.

Such a configuration helps to allow the user to estimate the SOC of the drive battery 410 to be obtained after the external power supply is performed.

This configuration raises user's awareness of saving electric power to be used in the external power supply, encouraging the next action such as charging or saving the electric power.

In one example where the SOC of the drive battery 410 is estimated to become significantly low after the external power supply is performed, the configuration helps to allow the user to charge the drive battery 410 at a charging place such as a nearby charging point before performing the external power supply.

In another example where the SOC of the drive battery 410 is estimated to be enough after the external power supply is performed (e.g., the SOC enough for the vehicle 1 to travel to the nearest charging point is secured), the configuration helps to allow the user to perform the external power supply with a sense of security.

In some embodiments, the vehicle 1 may include the communicator 200 configured to transmit data to the user terminal 600. The communicator 200 may be configured to, when the first determiner 114 determines that the current position data is the same as or similar to the location data on the location where the external power supply has been performed in the past, transmit the data including the past external-power-supply power consumption to the user terminal 600.

In such embodiments, the vehicle 1 may cause the user terminal 600 to display the external-power-supply power consumption data on the past external-power-supply power consumption and the SOC data on the drive battery 410, when the vehicle 1 is determined to have performed the external power supply at the stop position in the past.

Such a configuration of the vehicle 1 helps to provide the user with the external-power-supply use history data even if he/she is distant from the vehicle 1.

The user terminal 600 holding the past external-power-supply use history helps to allow the user to check the data on the external power supply any time.

### Second Example Embodiment

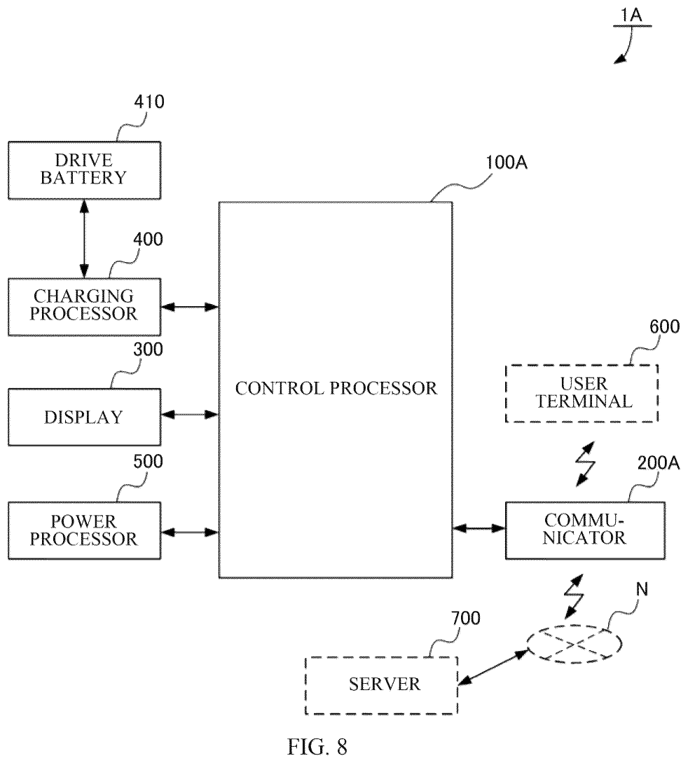

A vehicle 1A according to a second example embodiment of the disclosure will now be described with reference to FIGS. 8 to 12.

Note that components denoted by the same reference numerals as those in the first example embodiment have similar operations, and thus will not be described in detail below.

### <Configuration of Vehicle 1A>

Referring to FIG. 8, the vehicle 1A according to the present example embodiment may include a control processor 100A, a communicator 200A, the display 300, the charging processor 400, the drive battery 410, and the power processor 500.

Note that details of a configuration of the control processor 100A will be described later.

In the present example embodiment, the communicator 200A may be a device, such as a known wireless communication module, that transmits data outputted from the control processor 100A to the user terminal 600.

Non-limiting examples of the user terminal 600 may include a smartphone and a tablet.

The communicator 200A may transmit the data to the user terminal 600 by a method such as communication via a network N or short-range wireless communication via Bluetooth or a wireless LAN.

Non-limiting examples of the network N may include the Internet and any other system having a networking functionality.

In the present example embodiment, the communicator 200A may transmit data such as external-power-supply use history data outputted from the control processor 100A to the user terminal 600.

The user terminal 600 may cause its unillustrated display to display the external-power-supply use history data received from the communicator 200A.

Note that a display mode of the external-power-supply use history data to be displayed on the user terminal 600 will be described later.

In the present example embodiment, under the control of the control processor 100A, the communicator 200A may communicate with a server 700 holding weather data via the network N to thereby acquire the weather data obtained in performing the external power supply.

### <Configuration of Control Processor 100A>

The control processor 100A includes one or more processors, and one or more memories communicably coupled to the one or more processors.

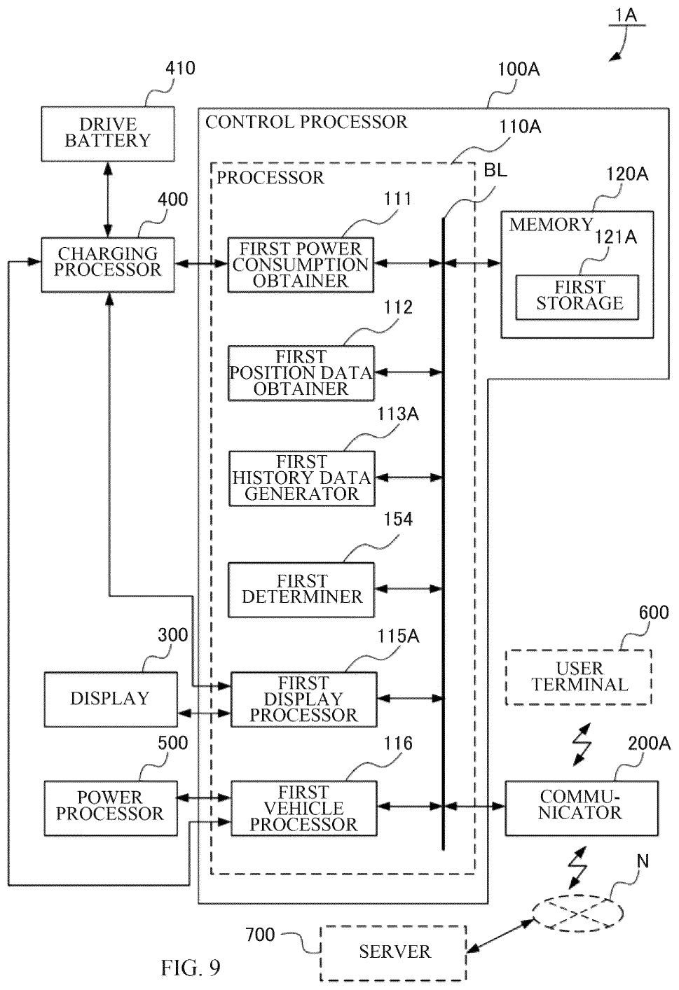

Referring to FIG. 9, the control processor 100A according to the present example embodiment may include a processor 110A and a memory 120A.

The processor 110A and the memory 120A may input and output data to each other via the bus line BL.

Note that a configuration of the processor 110A will be described later.

The memory 120A may include an unillustrated storage such as a ROM or a RAM.

The memory 120A may hold a control program, various types of data outputted from the processor 110A, and any other data.

In the present example embodiment, the memory 120A may include a first storage 121A.

The first storage 121A may hold the external-power-supply use history data in which the data on the location where the electric power of the drive battery 410 has been used for the external power supply, the external-power-supply power consumption data, and the weather data obtained in performing the external power supply are linked with each other.

The first storage 121 may hold the external-power-supply use history data received from the processor 110A to be described later.

Note that the external-power-supply use history data to be held in the first storage 121A will be described later.

### <Configuration of Processor 110A>

As illustrated in FIG. 9, the processor 110A may include the first power consumption obtainer 111, the first position data obtainer 112, a first history data generator 113A, the first determiner 114, a first display processor 115A, and the first vehicle processor 116.

The first history data generator 113A may generate the external-power-supply use history data in which the data on the location where the electric power of the drive battery 410 has been used for the external power supply, the external-power-supply power consumption data, and the weather data obtained in performing the external power supply are linked with each other.

In the present example embodiment, before generating the external-power-supply use history data, the first history data generator 113A may communicate with the server 700 via the communicator 200A to thereby acquire data including the weather data obtained on a date when the external power supply has been performed.

In the present example embodiment, upon receiving data indicating that the vehicle 1A has started up from the first vehicle processor 116, the first history data generator 113A may communicate with the server 700 via the communicator 200A to thereby acquire the weather data obtained on the date when the external power supply has been performed.

In the present example embodiment, the first history data generator 113A may generate the external-power-supply use history data in which the position data received from the first position data obtainer 112, the external-power-supply power consumption data received from the first power consumption obtainer 111, and the weather data (e.g., weather and temperature) obtained in performing the external power supply and acquired from the server 700 are linked with each other.

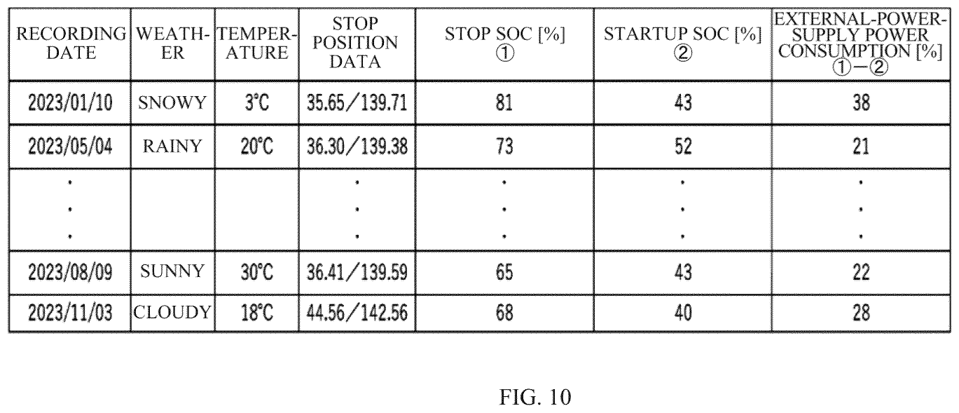

An example of the external-power-supply use history data will now be described with reference to FIG. 10.

In the example illustrated in FIG. 10, the first history data generator 113A according to the present example embodiment may generate the external-power-supply use history data in which the recording date, the weather, the temperature, the stop position data, the stop SOC, the startup SOC, and the external-power-supply power consumption are linked with each other.

In the present example embodiment, the first history data generator 113A may output the external-power-supply use history data to the first storage 121A via the bus line BL, and cause the first storage 121A to hold the external-power-supply use history data.

In the present example embodiment, upon receiving data indicating that the vehicle 1A has stopped from the first vehicle processor 116, the first display processor 115A may output a request for the acquisition of the SOC data to the charging processor 400, and acquire the SOC data on the drive battery 410.

If the first determiner 114 determines that the current position data acquired from the first position data obtainer 112 is the same as or similar to the location data on the location where the external power supply has been performed in the past, the first display processor 115A causes the display 300 to display data including past external-power-supply power consumption.

In the present example embodiment, upon receiving a determination result indicating that the vehicle 1A has the history of stopping within the predetermined distance, such as 500 meters, from the current position from the first determiner 114, the first display processor 115A may cause the display 300 to display the external-power-supply use history data received from the first determiner 114.

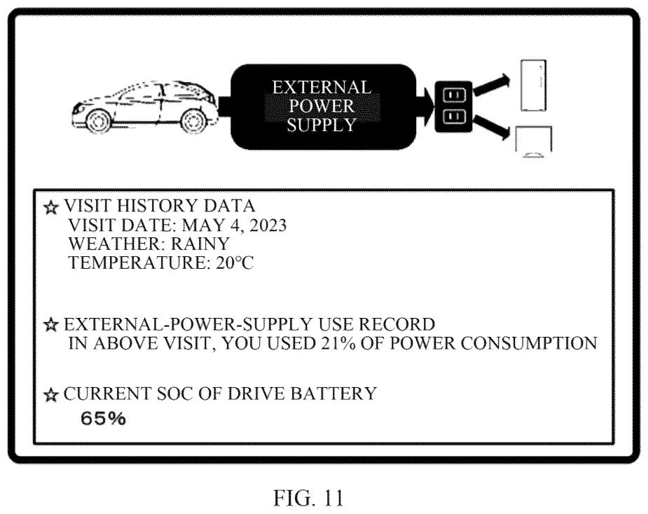

In the example illustrated in FIG. 11, the first display processor 115A may cause the display 300 to display visit history data (e.g., a visit date, weather, and temperature) and an external-power-supply use record, based on the external-power-supply use history data received from the first determiner 114.

The first display processor 115A may cause the display 300 to display the SOC data on the drive battery 410 acquired from the charging processor 400.

### <Flow of Processing of Generating External-Power-Supply Use History Data to be Performed by Vehicle 1A>

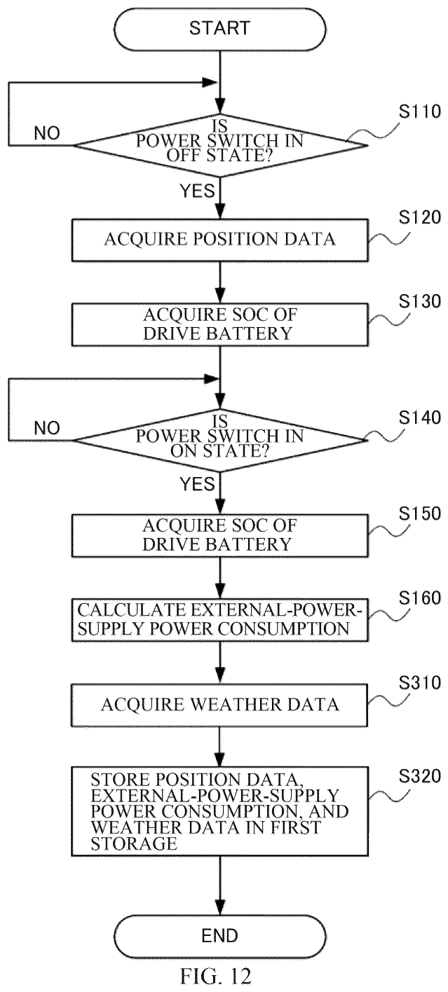

An exemplary flow of processing of generating the external-power-supply use history data to be held in the first storage 121A of the vehicle 1A to be performed by the vehicle 1A will now be described with reference to FIG. 12.

The first vehicle processor 116 may determine whether the power switch has changed from the on state to the off state, based on data acquired from the power processor 500 (step S110).

If determining that the power switch has not changed from the on state to the off state, based on the data acquired from the power processor 500 (step S110: NO), the first vehicle processor 116 may return the processing and shift to the standby state.

If determining that the power switch has changed from the on state to the off state, based on the data acquired from the power processor 500 (step S110: YES), the first vehicle processor 116 may cause the processing to proceed to step S120.

The first vehicle processor 116 may cause the first position data obtainer 112 to acquire the position data on the vehicle 1A (step S120), and cause the processing to proceed to step S130.

The first power consumption obtainer 111 may acquire the SOC of the drive battery 410 from the charging processor 400 (step S130), and cause the processing to proceed to step S140.

The first vehicle processor 116 may determine whether the power switch has changed from the off state to the on state, based on data acquired from the power processor 500 (step S140).

If determining that the power switch has not changed from the off state to the on state, based on the data acquired from the power processor 500 (step S140: NO), the first vehicle processor 116 may return the processing and shift to the standby state.

If determining that the power switch has changed from the off state to the on state, based on the data acquired from the power processor 500 (step S140: YES), the first vehicle processor 116 may cause the processing to proceed to step S150.

The first power consumption obtainer 111 may acquire the SOC of the drive battery 410 from the charging processor 400 (step S150), and cause the processing to proceed to step S160.

The first power consumption obtainer 111 may calculate the external-power-supply power consumption, based on the SOC of the drive battery 410 acquired in step S130 and the SOC of the drive battery 410 acquired in step S150 (step S160), and cause the processing to proceed to step S310.

The first history data generator 113A may acquire the weather data obtained on the date when the external power supply has been performed from the server 700 (step S310), and cause the processing to proceed to step S320.

The first history data generator 113A may cause the first storage 121A to hold the external-power-supply use history data in which the position data acquired in step S120, the respective pieces of the data on the external-power-supply power consumption acquired in steps S130, S150, and S160, and the weather data acquired in step S310 are linked with each other (step S320), and end the processing.

Note that an exemplary flow of processing of causing the display 300 to display the external-power-supply use history data to be performed by the vehicle 1A is similar to the flow of the processing to be performed by the vehicle 1 according to the first example embodiment described above, and thus will not be described in detail below.

### Workings and Example Effects

In the example embodiments described above, the first history data generator 113A of the vehicle 1A may cause the first storage 121A to hold the data including the data on the location where the electric power of the drive battery 410 has been used for the external power supply, the external-power-supply power consumption, and the weather data obtained in performing the external power supply.

In such embodiments, the vehicle 1A may cause the display 300 to display the external-power-supply power consumption data on the past external-power-supply power consumption, the current SOC data on the drive battery 410, and the weather data obtained in performing the external power supply, when the vehicle 1A is determined to have performed the external power supply at the position where the vehicle 1A has stopped traveling, in the past.

In view of the fact that the power consumption to be used changes greatly with the weather and temperature depending on the device to be operated by the external power supply, the vehicle 1A may provide the user with the weather data (e.g., the weather and temperature) obtained in performing the external power supply.

Such a configuration helps to allow the user to estimate whether the current external-power-supply power consumption exceeds the past external-power-supply power consumption, based on current weather data and the past weather data obtained in performing the external power supply in the past.

### Third Example Embodiment

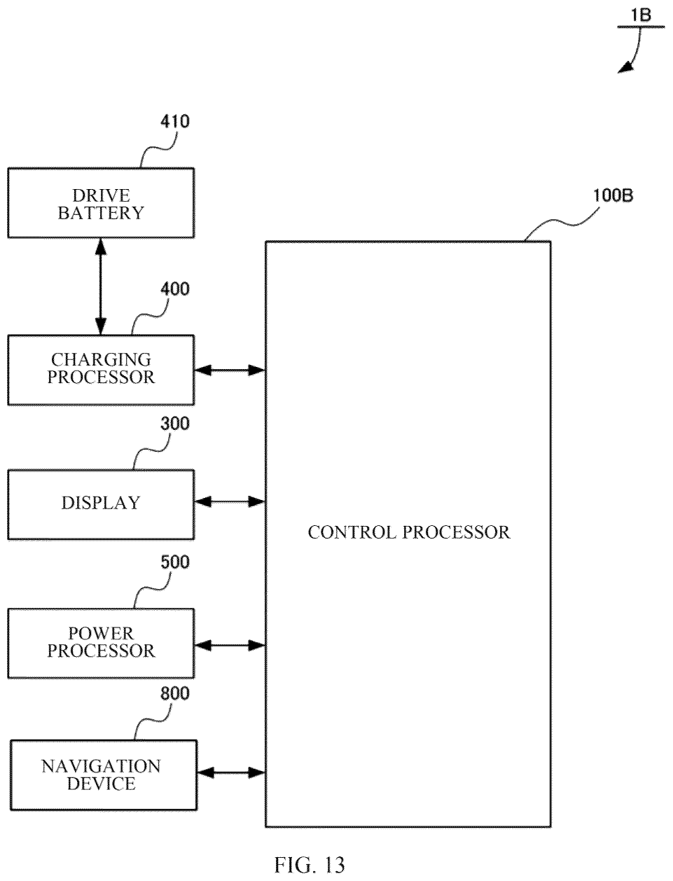

A vehicle 1B according to a third example embodiment of the disclosure will now be described with reference to FIGS. 13 to 16.

### <Configuration of Vehicle 1B>

Referring to FIG. 13, the vehicle 1B according to the present example embodiment may include a control processor 100B, the display 300, the charging processor 400, the drive battery 410, the power processor 500, and a navigation device 800.

Note that the control processor 100B will be described later.

In the present example embodiment, the display 300 may be a display panel, such as a liquid crystal panel, that is installed in a vehicle compartment of the vehicle 1B and displays data under the control of the control processor 100B.

In the present example embodiment, the display 300 may display data such as external-power-supply use history data outputted from the control processor 100B.

Note that a display mode of the external-power-supply use history data to be displayed by the display 300 will be described later.

In the present example embodiment, the charging processor 400 may control processing such as charging the drive battery 410 for travel of the vehicle 1B or performing the external power supply using the electric power of the drive battery 410.

The charging processor 400 may control a device such as an unillustrated inverter to convert the electric power of the drive battery 410 into alternating-current electric power and supply the alternating-current electric power through a port such as an electrical outlet installed inside or outside the vehicle 1B.

In the present example embodiment, the charging processor 400 may detect data such as the SOC of the drive battery 410.

In the present example embodiment, upon receiving a request for the acquisition of the SOC data from the control processor 100B to be described later, the charging processor 400 may output the SOC data on the drive battery 410 to the control processor 100B.

In the present example embodiment, the power processor 500 may control a condition such as a timing of supplying electric power to respective devices included in the vehicle 1B.

In the present example embodiment, the power processor 500 may detect data including the on state and the off state of the power switch operated by the user in starting up and stopping the vehicle 1B, and output a detection result to the control processor 100B.

In the present example embodiment, the navigation device 800 may calculate a travel route from the current position to a destination set by the user, and execute route guidance while displaying the calculated travel route.

In the present example embodiment, upon setting the destination, the navigation device 800 may output, to the control processor 100B, data indicating that the destination has been set, location data on the destination, and travel distance data on the calculated travel route to the destination.

### <Configuration of Control Processor 100B>

The control processor 100B includes one or more processors, and one or more memories communicably coupled to the one or more processors.

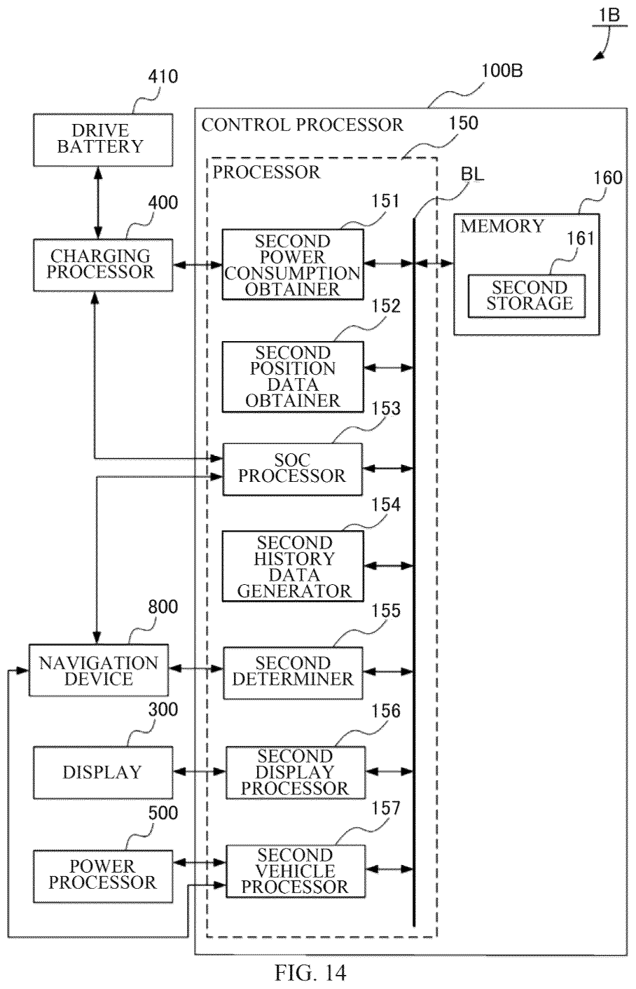

Referring to FIG. 14, the control processor 100B according to the present example embodiment may include a processor 150 and a memory 160.

The processor 150 and the memory 160 may input and output data to each other via the bus line BL.

Note that a configuration of the processor 150 will be described later.

The memory 160 may include an unillustrated storage such as a ROM or a RAM.

The memory 160 may hold a control program, various types of data outputted from the processor 150, and any other data.

In the present example embodiment, the memory 160 may include a second storage 161.

The second storage 161 may hold the external-power-supply use history data in which the data on the location where the electric power of the drive battery 410 has been used for the external power supply is linked with the data including the external-power-supply power consumption.

The second storage 161 may hold the external-power-supply use history data outputted from the processor 150 to be described later.

### <Configuration of Processor 150>

As illustrated in FIG. 14, the processor 150 may include a second power consumption obtainer 151, a second position data obtainer 152, a SOC processor 153, a second history data generator 154, a second determiner 155, a second display processor 156, and a second vehicle processor 157. In one embodiment, the SOC processor 153 may serve as a “state-of-charge processor”.

The second power consumption obtainer 151 may acquire the external-power-supply power consumption used by the user.

In the present example embodiment, the second power consumption obtainer 151 may acquire the external-power-supply power consumption data on the external-power-supply power consumption used by the user, based on data such as the SOC of the drive battery 410.

In the present example embodiment, upon receiving input such as data indicating that the vehicle 1B has stopped from the second vehicle processor 157 to be described later, the second power consumption obtainer 151 may output a request for the acquisition of the SOC data to the charging processor 400, and acquire the SOC data on the drive battery 410.

In the present example embodiment, upon receiving input such as data indicating that the vehicle 1B has started up from the second vehicle processor 157 to be described later, the second power consumption obtainer 151 may output a request for the acquisition of the SOC data to the charging processor 400, and acquire the SOC data on the drive battery 410.

In the present example embodiment, the second power consumption obtainer 151 may calculate a value such as a difference value of a difference between a value of the SOC data on the drive battery 410 acquired upon stopping the traveling of the vehicle 1B and a value of the SOC data on the drive battery 410 acquired upon starting up the vehicle 1B.

In the present example embodiment, the second power consumption obtainer 151 may output, to the second history data generator 154 to be described later via the bus line BL, data including the SOC data on the drive battery 410 acquired upon stopping the traveling of the vehicle 1B, the SOC data on the drive battery 410 acquired upon starting up the vehicle 1B, and the difference value (i.e., the external-power-supply power consumption data).

The second position data obtainer 152 acquires current position data on the vehicle 1B.

In the present example embodiment, upon receiving the data indicating that the vehicle 1B has stopped traveling from the second vehicle processor 157 to be described later, the second position data obtainer 152 may acquire the position data on the vehicle 1B (e.g., its latitude and longitude) together with time data, based on electric waves received from satellites of a positioning system such as the GPS.

In the present example embodiment, the second position data obtainer 152 may output the acquired position data and time data to the second history data generator 154 to be described later via the bus line BL.

The SOC processor 153 calculates the SOC of the drive battery 410 to be obtained upon arrival at the destination, based on the acquired current position data.

In the present example embodiment, upon receiving input such as a request for calculation of the SOC from the second vehicle processor 157 to be described later, the SOC processor 153 may calculate a power consumption to be used in traveling from the current position to the destination, based on data such as an average specific power consumption of the vehicle 1B as well as a travel distance of the travel route to the destination received from the navigation device 800.

In the present example embodiment, upon receiving the request for the calculation of the SOC from the second vehicle processor 157 to be described later, the SOC processor 153 may output a request for the acquisition of the SOC to the charging processor 400, and acquire the current SOC of the drive battery 410.

In the present example embodiment, the SOC processor 153 may calculate the SOC of the drive battery 410 to be obtained upon the arrival at the destination, based on data such as the calculated power consumption (i.e., the power consumption to be used in traveling from the current position to the destination) or the current SOC of the drive battery 410 acquired from the charging processor 400.

In the present example embodiment, the SOC processor 153 may output a value of the SOC of the drive battery 410 to be obtained upon the arrival at the destination and a value of the current SOC of the drive battery 410 to the second display processor 156 to be described later via the bus line BL.

The second history data generator 154 may generate the external-power-supply use history data in which the data on the location where the external power supply has been performed is linked with the data including the external-power-supply power consumption data.

In the present example embodiment, the second history data generator 154 may generate the external-power-supply use history data in which the position data and the time data received from the second position data obtainer 152 are linked with the external-power-supply power consumption data received from the second power consumption obtainer 151.

Note that the external-power-supply use history data to be generated by the second history data generator 154 is similar to the external-power-supply use history data illustrated in FIG. 3 to be generated by the first history data generator 113 of the vehicle 1 according to the first example embodiment, and thus will not be described in detail below.

The second determiner 155 determines whether the location data on the destination set by the user is the same as or similar to the location data on the location where the external power supply has been performed in the past.

In the present example embodiment, upon receiving input such as the location data on the destination from the navigation device 800, the second determiner 155 may determine whether the vehicle 1B has a history of stopping traveling within a predetermined distance, such as 500 meters, from the destination, by referring to stop position data included in the external-power-supply use history data held in the second storage 161.

If determining that the vehicle 1B has the history of stopping traveling within the predetermined distance, such as 500 meters, from the destination set by the user, the second determiner 155 may output a determination result indicating that the vehicle 1B has the history of stopping within the predetermined distance, such as 500 meters, from the destination as well as external-power-supply use history data obtained on a past date when the vehicle 1B has stopped traveling within the predetermined distance, such as 500 meters, from the destination, to the second display processor 156 to be described later via the bus line BL.

If determining that the vehicle 1B has no history of stopping within the predetermined distance, such as 500 meters, from the destination set by the user, the second determiner 155 may output a determination result indicating that the vehicle 1B has no history of stopping within the predetermined distance, such as 500 meters, from the destination, to the second display processor 156 to be described later via the bus line BL.

In the present example embodiment, upon receiving the data indicating that the vehicle 1B has stopped from the second vehicle processor 157 to be described later, the second display processor 156 may output a request for the acquisition of the SOC to the charging processor 400, and acquire the SOC of the drive battery 410.

If the second determiner 155 determines that the location data on the destination is the same as or similar to the location data on the location where the external power supply has been performed in the past, the second display processor 156 causes the display 300 to display data including past external-power-supply power consumption and the SOC of the drive battery 410 to be obtained upon the arrival at the destination.

In the present example embodiment, upon receiving the determination result indicating that the vehicle 1B has the history of stopping within the predetermined distance, such as 500 meters, from the destination from the second determiner 155, the second display processor 156 may cause the display 300 to display the external-power-supply use history data received from the second determiner 155.

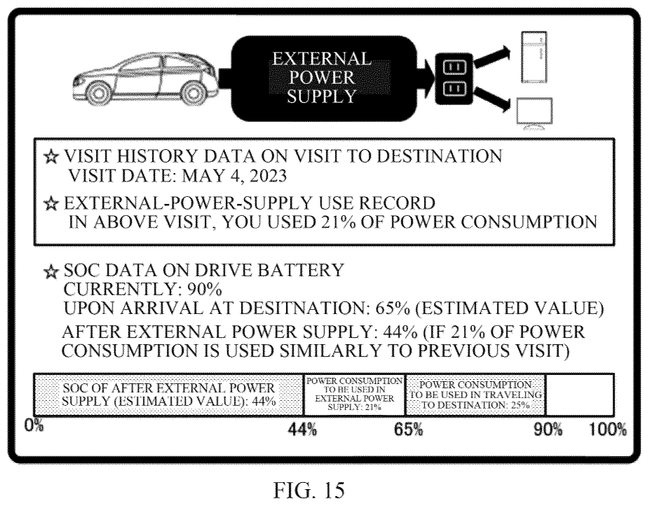

In the example illustrated in FIG. 15, the second display processor 156 according to the present example embodiment may cause the display 300 to display visit history data on a past visit to the destination, an external-power-supply use record, and the SOC data on the drive battery 410, based on data including a calculation result (i.e., the power consumption to be used in traveling from the current position to the destination) received from the SOC processor 153 and the external-power-supply use history data received from the second determiner 155.

In the example illustrated in FIG. 15, the second display processor 156 may cause the display 300 to display a graph of the SOC data on the drive battery 410 in which a fully charged state of the drive battery 410 is defined as 100%. This graph may indicate the current SOC (of 90% in this example) of the drive battery 410 and the power consumption (of 25% in this example) to be used in traveling from the current position to the destination.

In this example, the second display processor 156 according to the present example embodiment may cause the display 300 to display the SOC of the drive battery 410 (of 44% in this example) to be obtained if the same external-power-supply power consumption (of 21% in this example) as that in a previous visit to the destination is used in a current visit to the destination.

In the present example embodiment, upon receiving input such as the determination result indicating that the vehicle 1B has no history of stopping within the predetermined distance, such as 500 meters, from the destination from the second determiner 155, the second display processor 156 may cause the display 300 to display data indicating that the vehicle 1B has no external-power-supply use history.

In the present example embodiment, the second vehicle processor 157 may control processing of an entirety of the vehicle 1B in accordance with the control program held in the memory 160.

In the present example embodiment, the second vehicle processor 157 may determine whether the destination has been set in the navigation device 800.

In the present example embodiment, upon receiving input such as data indicating that the destination has been set from the navigation device 800, the second vehicle processor 157 may determine that the destination has been set in the navigation device 800.

In the present example embodiment, if determining that the destination has been set in the navigation device 800, the second vehicle processor 157 may output the request for the calculation of the SOC to the SOC processor 153, and cause the SOC processor 153 to calculate the SOC of the drive battery 410 to be obtained upon the arrival at the destination.

In the present example embodiment, the second vehicle processor 157 may acquire data including the on state and the off state of the power switch from the power processor 500, and determine whether the power switch has changed from the on state to the off state.

In the present example embodiment, if determining that the power switch has changed from the on state to the off state, the second vehicle processor 157 may output the data indicating that the vehicle 1B has stopped, to the second power consumption obtainer 151 and the second position data obtainer 152 via the bus line BL.

In the present example embodiment, the second vehicle processor 157 may acquire data including the on state and the off state of the power switch from the power processor 500, and determine whether the power switch has changed from the off state to the on state.

In the present example embodiment, if determining that the power switch has changed from the off state to the on state, the second vehicle processor 157 may output the data indicating that the vehicle 1B has started up, to the second power consumption obtainer 151 via the bus line BL.

### <Flow of Processing of Displaying External-Power-Supply Use History Data to be Performed by Vehicle 1B>

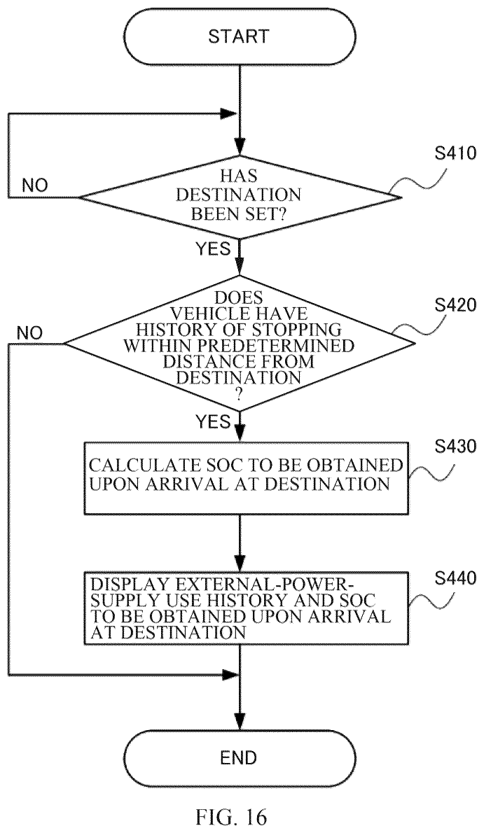

An exemplary flow of processing of causing the display 300 to display the external-power-supply use history data to be performed by the vehicle 1B will now be described with reference to FIG. 16.

The second vehicle processor 157 may determine whether the destination has been set, based on data received from the navigation device 800 (step S410).

If determining that the destination has not been set, based on the data received from the navigation device 800 (step S410: NO), the second vehicle processor 157 may return the processing and shift to the standby state.

If determining that the destination has been set, based on the data received from the navigation device 800 (step S410: YES), the second vehicle processor 157 may cause the processing to proceed to step S420.

The second determiner 155 may determine whether the vehicle 1B has the history of stopping within the predetermined distance, such as 500 meters, from the destination, based on the location data on the destination set by the user and the stop position data included in the external-power-supply use history data held in the second storage 161 (step S420).

If determining that the vehicle 1B has no history of stopping within the predetermined distance, such as 500 meters, from the destination (step S420: NO), the second determiner 155 may end the processing.

If determining that the vehicle 1B has the history of stopping within the predetermined distance, such as 500 meters, from the destination (step S420: YES), the second determiner 155 may cause the processing to proceed to step S430.

The SOC processor 153 may calculate the SOC of the drive battery 410 to be obtained upon the arrival at the destination (step S430), and cause the processing to proceed to step S440.

The second display processor 156 may cause the display 300 to display the external-power-supply use history data and the SOC of the drive battery 410 to be obtained upon the arrival at the destination (step S440), and end the processing.

### Workings and Example Effects

In the example embodiments described above, the vehicle 1B may include the second storage 161, the second position data obtainer 152, the SOC processor 153, the second determiner 155, the second display processor 156, and the navigation device 800. The second storage 161 is configured to hold: the data on the location where the electric power of the drive battery 410 has been used for the external power supply; and the data including the external-power-supply power consumption. The data on the location is linked with the data including the external-power-supply power consumption. The second position data obtainer 152 is configured to acquire the current position data on the vehicle 1B. The SOC processor 153 is configured to calculate the SOC of the drive battery 410 to be obtained upon the arrival at the destination. The second determiner 155 is configured to determine whether the location data on the destination is the same as or similar to the location data on the location where the external power supply has been performed in the past. The second display processor 156 is configured to, when the second determiner 155 determines that the location data on the destination is the same or similar to the location data on the location where the external power supply has been performed in the past, cause the display 300 to display the data including the past external-power-supply power consumption and the SOC of the drive battery 410 to be obtained upon the arrival at the destination.

In other words, the vehicle 1B may determine whether the external power supply has been performed at the set destination in the past, when the destination has been set in the navigation device 800.

In such embodiments, if determining that the external power supply has been performed at the destination in the past, the vehicle 1B may cause the display 300 to display the past external-power-supply use history and the SOC of the drive battery 410 to be obtained upon the arrival at the destination.

Such a configuration helps to allow the user to acquire past external-power-supply use history data and estimate a power consumption to be used upon current stopping of the vehicle 1B.

This configuration helps to allow the user to estimate the power consumption to be used upon current stopping of the vehicle 1, based on types and the number of devices operated by the external power supply in a past visit, the displayed external-power-supply use history, and types and the number of devices to be operated by the external power supply in a current visit.

In such a situation where the number of devices to be operated by the external power supply is less in the current visit than in the past visit, the configuration helps to allow the user to estimate that the external-power-supply power consumption is to become less in the current visit than in the past visit.

In some embodiments, if determining that the external power supply has been performed at the destination in the past, the vehicle 1B may cause the display 300 to display the SOC data on the drive battery 410 to be obtained upon the arrival at the destination.

Such a configuration helps to allow the user to estimate the SOC of the drive battery 410 to be obtained after the external power supply is performed, based on the SOC data on the drive battery 410 to be obtained upon the arrival at the destination.

This configuration raises the user's awareness of saving the electric power to be used in the external power supply, encouraging the next action such as charging or saving the electric power.

In one example where the SOC of the drive battery 410 is estimated to become significantly low after the external power supply is performed at the destination, the configuration helps to allow the user to charge the drive battery 410 at a charging point before arriving at the destination.

In another example where the SOC of the drive battery 410 is estimated to be enough after the external power supply is performed at the destination (e.g., the SOC enough for the vehicle 1B to travel to the nearest charging point is secured), the configuration helps to allow the user to perform the external power supply with a sense of security.

### Modification Example 1

A display panel, a processor, and a memory included in the navigation device 800 may serve respectively as the display 300, the processor 150, and the memory 160 of the vehicle 1B described above.

### Modification Example 2

The external-power-supply use history data to be generated by any of the vehicles 1, 1A, and 1B described above may additionally include time data on time when the external power supply has been performed.

In such a situation where the external power supply is performed in a location such as a campground or a shelter, the power consumption for lighting or any other purpose may be higher at night than in daytime. In view of this, the external-power-supply use history data may additionally include the time data on the time when the external power supply has been performed.

Such a configuration helps to allow the user to perform a highly accurate estimation of the power consumption to be used upon current stopping of any of the vehicles 1, 1A, and 1B.

### Modification Example 3

The user may be allowed to edit the external-power-supply use history data generated by the vehicle 1 described above.

The user may acquire the external-power-supply use history data by causing a device such as the user terminal 600 to communicate with the vehicle 1.

At a timing such as when returning home from a destination, the user may cause the first storage 121 to hold the external-power-supply use history data acquired from the vehicle 1 and data including device data on a device to which the external power supply has been performed in such a manner that the external-power-supply use history data is linked with the data including the device data.

Such a configuration provides the user with the data including the device data on the device to which the external power supply has been performed and the external-power-supply power consumption data, on an occasion of revisiting the past destination. This helps to perform a more highly accurate estimation of the power consumption to be used upon current stopping of the vehicle 1.

### Modification Example 4

In some embodiments, when stopping at a position where the vehicle 1 described above has not stopped in the past, the vehicle 1 may calculate an average value of past external-power-supply power consumptions, based on data including the external-power-supply power consumptions included in respective pieces of the external-power-supply use history data held in the first storage 121, and cause the display 300 to display a calculation result.

Such a configuration helps to allow the user to perform an estimation of the power consumption to be used upon current stopping of the vehicle 1, based on the external-power-supply use histories, even when the vehicle 1 stops at the position where the vehicle 1 has not stopped in the past.

In some embodiments, it is possible to implement the vehicle 1 of the example embodiment of the disclosure by recording the process to be executed by the first display processor 115 and the first vehicle processor 116 described above on a non-transitory recording medium readable by a computer system, and causing the computer system to load the program recorded on the non-transitory recording medium onto the memory 120 to execute the program.

The computer system as used herein may encompass an operating system (OS) and a hardware such as a peripheral device.

In addition, when the computer system utilizes a World Wide Web (WWW) system, the “computer system” may encompass a website providing environment (or a website displaying environment).

The program may be transmitted from a computer system that contains the program in a storage device or the like to another computer system via a transmission medium or by a carrier wave in a transmission medium.

The “transmission medium” that transmits the program may refer to a medium having a capability to transmit data, including a network (e.g., a communication network) such as the Internet and a communication link (e.g., a communication line) such as a telephone line.

The program may be directed to implement a part of the operation described above.

The program may be a so-called differential file (differential program) configured to implement the operation by a combination of a program already recorded on the computer system.

Although some embodiments of the disclosure have been described in detail with reference to the accompanying drawings, all vehicles implementable through design modifications appropriately made by those skilled in the art based on the vehicles according to the foregoing example embodiments of the disclosure also fall within the scope of the disclosure as long as they include the gist of the disclosure.

Those skilled in the art can conceive of various modifications and alterations within the scope of the inventive concept of the disclosure, and it is understood that these modifications and alterations also fall within the scope of the disclosure.

For example, those skilled in the art may add some constituent elements to, delete some constituent elements from, or make some design modifications to the foregoing example embodiments as appropriate, or add some steps to, remove some steps from, or make some modifications to conditions of the foregoing example embodiments as appropriate. These embodiments are also included in the scope of the disclosure as long as they include the gist of the disclosure.

Further, it will be understood that other workings and effects than those provided by the foregoing example embodiments and apparent from the description herein or appropriately conceivable by those skilled in the art are naturally provided by the disclosure.

Various embodiments of the disclosure may be provided by appropriately combining the constituent elements disclosed in the foregoing example embodiments.

For example, some constituent elements may be deleted from all the constituent elements disclosed in the foregoing example embodiments.

Furthermore, constituent elements across different embodiments may be combined as appropriate.

It is also possible to achieve at least the following example configuration (1) from the example embodiments and their modification examples described above.

(1)

A vehicle including:
a control processor; and
a display, in which
the control processor includes
   one or more processors, and
   one or more memories communicably coupled to the one or more processors,
the one or more memories include a storage configured to hold: data on a location where electric power of a drive battery has been used for external power supply; and data including a power consumption used in the external power supply, the data on the location being linked with the data including the power consumption, and
the one or more processors are configured to
   calculate a state of charge of the drive battery to be obtained upon arrival at a destination, based on current position data on the vehicle, and
   cause, when determining that location data on the destination is same as or similar to the data on the location where the external power supply has been performed in past, the display to display data including the state of charge of the drive battery to be obtained upon the arrival at the destination and the power consumption used in the external power supply in the past.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term “substantially”, “approximately”, “about”, and its variants having a similar meaning thereto are defined as being largely but not necessarily wholly what is specified as understood by one of ordinary skill in the art.

The term “disposed on/provided on/formed on” and its variants having a similar meaning thereto as used herein refer to elements disposed directly in contact with each other or indirectly by having intervening structures therebetween.

Each of the processor 110 illustrated in FIG. 2, the processor 110A illustrated in FIG. 9, and the processor 150 illustrated in FIG. 14 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of each of the processor 110, the processor 110A, and the processor 150. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of each of the processor 110 illustrated in FIG. 2, the processor 110A illustrated in FIG. 9, and the processor 150 illustrated in FIG. 14.

1. A vehicle comprising:
a first storage configured to hold: data on a location where electric power of a drive battery has been used for external power supply; and data comprising a power consumption used in the external power supply, the data on the location being linked with the data comprising the power consumption;
a first position data obtainer configured to, when the vehicle stops traveling, acquire current position data on the vehicle;
a first determiner configured to determine whether the current position data is same as or similar to the data on the location where the external power supply has been performed in past; and
a first display processor configured to, when the first determiner determines that the current position data is the same as or similar to the data on the location where the external power supply has been performed in the past, cause a display to display the data comprising the power consumption used in the external power supply in the past.

2. The vehicle according to claim 1, further comprising a communicator configured to transmit data to a user terminal, wherein
the communicator is configured to, when the first determiner determines that the current position data is the same as or similar to the data on the location where the external power supply has been performed in the past, transmit the data comprising the power consumption used in the external power supply in the past to the user terminal.

3. The vehicle according to claim 1, wherein the first storage is configured to further hold data comprising weather data obtained in performing the external power supply.

4. A vehicle comprising:
a second storage configured to hold: data on a location where electric power of a drive battery has been used for external power supply; and data comprising a power consumption used in the external power supply, the data on the location being linked with the data comprising the power consumption;
a second position data obtainer configured to acquire current position data on the vehicle;
a state-of-charge processor configured to calculate a state of charge of the drive battery to be obtained upon arrival at a destination, based on the current position data;
a second determiner configured to determine whether location data on the destination is same as or similar to the data on the location where the external power supply has been performed in past; and
a second display processor configured to, when the second determiner determines that the location data on the destination is the same as or similar to the data on the location where the external power supply has been performed in the past, cause a display to display data comprising the state of charge of the drive battery to be obtained upon the arrival at the destination and the power consumption used in the external power supply in the past.

5. A vehicle comprising:
a control processor; and
a display, wherein
the control processor comprises
one or more processors, and
one or more memories communicably coupled to the one or more processors,
the one or more memories comprise a storage configured to hold: data on a location where electric power of a drive battery has been used for external power supply; and data comprising a power consumption used in the external power supply, the data on the location being linked with the data comprising the power consumption, and
the one or more processors are configured to, when determining that current position data on the vehicle acquired upon stopping traveling of the vehicle is same as or similar to the data on the location where the external power supply has been performed in past, cause the display to display the data comprising the power consumption used in the external power supply in the past.
